(19) United States
(12) Patent Application Publication
(10) Pub. No.: US 2020/0285673 A1
(43) Pub. Date: Sep. 10, 2020

(54) APPARATUS AND METHODS FOR SUPPLEMENTING USER ASSEMBLED DATA

(71) Applicant: JUST EAT HOLDING LIMITED, Borehamwood Hertfordshire (GB)

(72) Inventors: Khurom KIYANI, Borehamwood Hertfordshire (GB); Corwin PIERCE-BUTLER, Borehamwood Hertfordshire (GB)

(21) Appl. No.: 16/498,902

(22) PCT Filed: Mar. 29, 2018
(86) PCT No.: PCT/GB2018/050858

§ 371 Date: Sep. 27, 2019

(30) Foreign Application Priority Data
Mar. 29, 2017 (GB) 1705054.3

(51) Int. Cl. G06F 16/9035; G06F 16/908; G06F 16/958; G06F 16/906; G06Q 30/02

(52) U.S. Cl. CPC G06F 16/9035; G06F 16/908; G06Q 30/0204; G06F 16/906; G06F 16/972

(57) ABSTRACT

Disclosed herein is a method and apparatus for processing user requests for items. A server (100) is arranged to supplement those requests by offering additional items to supplement those already requested. It may do this by using an adaptive learning method. Embodiments may adapt to the possibility that new data items can be made available, or that user behaviour may change over time. The server (100) may use a system of scoring (each score relating to a probability of selection) to determine how to select between possible supplementary data items. In response to a new item being made available and for which no score exists, the server (100) may determine a score to be attributed to the new item. This may be determined by comparing an identifier of the new item with those of similar items to determine its score.

### FIELD OF THE INVENTION

The present invention relates to apparatus and methods for supplementing user assembled data.

### BACKGROUND

As data storage has become available on a much larger scale, a server may now store vast quantities of data, which makes it increasingly more difficult for a user to find all, or even any, of the data they are looking for. Also, common methods of data storage often result in similar data items being stored in separate locations so that a user, when selecting data items, may not be presented with all of the options that are most relevant/useful to them. In particular, useful items may be stored in sufficiently different locations that the user is unlikely to discover them even though they may be very useful.

This inefficiency in data storage presents a significant commercial opportunity because a user not finding all of the required data can cause money to be lost. In particular, in scenarios where the user being presented with the extra data may have resulted in an extra sale, this represents a missed opportunity.

These commercial opportunities however also present technical challenges because new data is continually uploaded to a server, and at the point of upload, it is not clear what the relationship is likely to be between a new data item and existing stored data items. Accordingly, any methods for addressing such problems will have to deal with large quantities of new and existing data, and to determine what data might similar or even useful in combination with the new data. Dealing with vast amounts of existing data may also create problems when assessing what existing data may be relevant. These present technical problems associated with providing a user with useful data they may otherwise not have retrieved.

Whilst an individual search query might use relatively small amounts of energy, in a practical server system handling many queries from each of many thousands or even millions of users, a reduction of a few percent in the relative energy cost of a single query may scale into a very significant absolute energy saving.

### SUMMARY OF THE INVENTION

Aspects and examples of the present disclosure are set out in the claims and aim to address at least these and other technical problems.

In an aspect there is provided a server comprising a data store, and a processor coupled to the data store, wherein the data store comprises: a plurality of type identifiers, each associated with a respective corresponding one of a plurality of first mappings; and a plurality of second mappings, each associated with at least one of said plurality of type identifiers, wherein each of the plurality of first mappings comprise a plurality of item identifiers each having a respective corresponding first mapping score attributed thereto, and wherein each of the plurality of second mappings comprise a plurality of item identifiers each having a respective corresponding second mapping score attributed thereto. The processor is configured to: obtain an item identifier associated with one of the second mappings; and update the one of the second mappings to include the item identifier and a second mapping score attributed to the item identifier, wherein the processor is configured to determine the second mapping score by parsing the item identifier using a first mapping selected from the plurality of first mappings based on the type identifier of the second mapping. The server is configured so that in the event that a request message is received, from a UE, for items identified in the second mapping, the server sends, to the UE, a supplement message comprising a supplementary item identifier selected from the second mapping based on the second mapping scores in said second mapping.

Embodiments are directed to the problem of how best to select supplementary data to be provided to a user in response to a particular request. The available set of data from which these supplementary items of data might be chosen can change dynamically. Growth of the data set poses a problem because the server may not know how to deal with new data items when selecting content for the supplement message. Embodiments of the present disclosure may enable the server to adapt its selection of this content as a data set grows by drawing inferences from other data sets of similar type (e.g. by using the first mappings).

In an embodiment the processor is configured to update the second mapping score associated with the supplementary item identifier based on an approval message received from the UE in response to the supplement message. This may enable the selection of content of the supplement message to adapt to the combined behaviour of all users. This adaptation (learning) may be applied solely to a single second mapping, but may also be propagated, indirectly, to other data sets of similar type by updating the score data held in the first mapping having the same type identifier as that second mapping. Updating the score in the first mapping ensures that new item identifiers are parsed using up-to-date data.

The approval message may comprise an instruction to amend the contents of the request message. This instruction may be to include the supplementary item in the request message. The supplement message may comprise a plurality of supplementary item identifiers as options for a user to select, and the user may be able to select one or more of these. Accordingly, the approval message may comprise an instruction to add one or more corresponding items to the request message.

The update to the scores may be determined based on the contents of the approval message. Where the content of the approval message indicates a selection of a supplementary item identifier, the processor may be configured to increment the score, and where no indication of selection is present, the processor may decrement the score. The size of the increments or decrements to the score may be determined based on the number of instances of selection indicated in the approval message and the score itself. This enables updates to the scores to be representative of the extent of the selection of the supplementary item identifier.

In an embodiment, the second mapping score may comprise an exploring component and an exploiting component. The processor may be configured to update the second mapping score by updating either and/or both components, and may be configured to select the supplementary item identifier based on either and/or both components. The exploring component may initially begin at a first value, and reduce over time to a second value. In some embodiments, the second value may be zero. In other embodiments, the second value may be greater than zero.

In an embodiment, the supplementary item identifier may be selected using a bandit algorithm. The processor may be configured to implement the bandit algorithm by updating the second mapping scores in accordance with a bandit algorithm. Using a bandit algorithm enables the processor to optimise the usefulness of a supplementary item identifier because the processor may develop over time a clear picture of the most useful supplementary item identifiers to send. This behaviour may be modified by using a parameter to adjust the ratio of the amount of exploring to the amount of exploiting being performed by the processor. The processor may then adapt its selection behaviour depending on the nature of the second mapping it is selecting from.

In an embodiment, the processor may be configured to obtain grams and/or bigrams of text from the obtained item identifier and the first mapping item identifiers. The processor may perform a textual analysis between these identifiers. This enables items which are similar in text to be identified, so that a second mapping score may be determined based on first mapping scores of items which are textually similar.

### FIGURES

Embodiments of the invention will now be described, by way of example only, with reference to the accompanying drawings in which:

FIG. 1 shows a schematic drawing of a network system.

FIG. 2 shows a timing diagram indicating a method of operation of the network system of FIG. 1.

FIG. 3 shows a timing diagram indicating a method of operation of the network system of FIG. 1.

FIG. 4 shows a schematic drawing of a network system.

### SPECIFIC DESCRIPTION

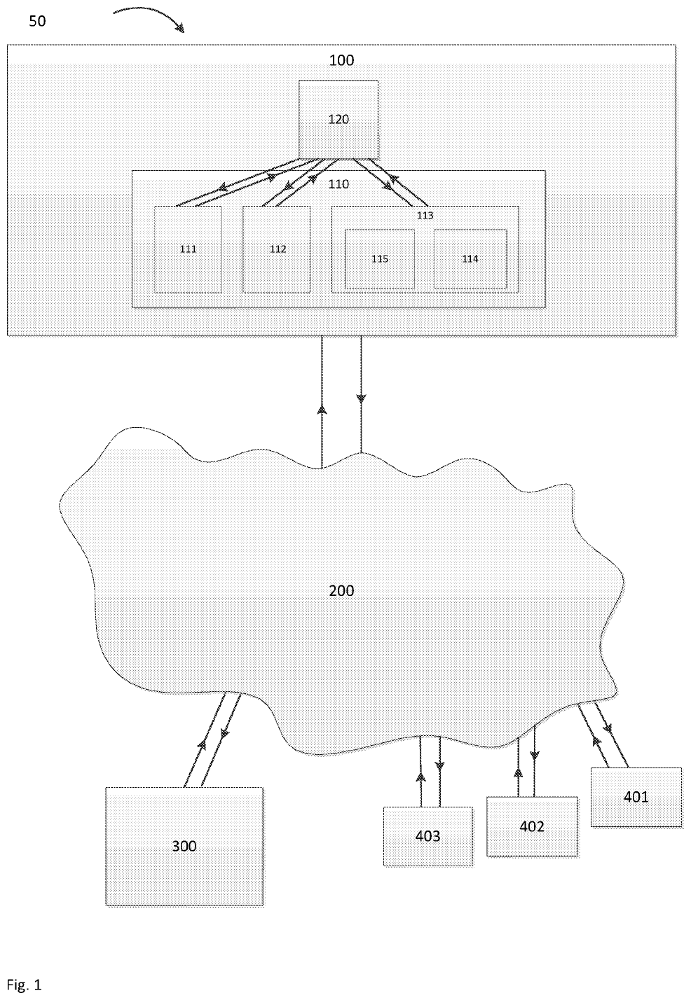

FIG. 1 shows a server 100 configured for processing user requests for items.

The server is arranged to supplement those requests by offering additional items to supplement those already requested. It may do this by using an adaptive learning method as described below. Embodiments may adapt to the possibility that new data items can be made available, or that user behaviour may change over time. For example, the server 100 may use a system of scoring (each score relating to a probability of selection) to determine how to select between possible supplementary data items. In response to a new item being made available and for which no score exists, the server 100 may determine a score to be attributed to the new item. This may be determined by comparing an identifier of the new item with those of similar items to determine its score.

New data items and their scores may then be stored, with a score, in a data store in the server 100. The server 100 is configured to select supplementary data items to be offered to a user, and the scores may be used to provide optimised selection of data items to be offered to the user. The new items are stored in the data store in two sorts of mapping. A first mapping is a generic mapping for all items from all data sources associated with a particular type. There are also second mappings which comprise all items from one specific data source. A first mapping therefore includes all items from second mappings associated with one particular type.

The server 100 may comprise a data store 110, and a processor 120 coupled to the data store, and be configured to obtain an item identifier associated with a second mapping 112, attribute a second mapping score to the item identifier by parsing the item identifier using a first mapping 111, and to select, from the second mapping 112, a second mapping item identifier to be included as a supplementary item identifier in a supplement message sent to a UE 300.

The network system 50 of FIG. 1 includes a server 100, a network 200, a user equipment 300, a first data source 401, a second data source 402 and a third data source 403. The server 100 comprises a data store 110 and a processor 120. The data store comprises a plurality of first mappings 111, a plurality of second mappings 112 and a plurality of associations 113 including a first association 114 10 and a second association 115. These are stored on volatile and/or non-volatile memory of the data store. The processor 120 is coupled to the data store 110 to enable reading and writing of the contents of the data store by the processor.

The server 100 is coupled, via the network 200, to communicate with each of the user equipment 300, the first data source 401, the second data source 402 and the third data source 403. The network 200 may be a wide area network, such as the internet. Communication between the server 100, the user equipment 300 and the data sources 401,402,403 may be provided by network messages sent over the wide area network.

The plurality of associations comprises a first association, and a second association. The first association links each of a plurality of type identifiers to a respective corresponding one of the plurality of first mappings. Each type identifier indicates a certain characteristic of the respective corresponding one first mapping. The first association then provides a direct, for example one-to-one, relationship between each type identifier and one first mapping.

The first association may be stored in the form of a data table or any other suitable data structure, which links every type identifier to its respective corresponding one first mapping. In one example, each type identifier may be a different type of cuisine, and each first mapping includes menu items from restaurants of that cuisine. An exemplary first association is illustrated below.

| Type identifier | First mapping |
|---|---|
| Type 1 | First mapping 1 |
| Type 2 | First mapping 2 |
| Type 3 | First mapping 3 |
| . . . | . . . |

The second association links each of the plurality of type identifiers to one or more of a plurality of corresponding second mappings. The second association is such that each type identifier may be associated with a plurality of second mappings, and each second mapping may be associated with a plurality of type identifiers. The second association may be stored in the form of a data table or any other suitable data structure, which links every type identifier to its associated second mappings. An exemplary second association is illustrated below.

| Type identifier | Second mappings |
|---|---|
| Type 1 | Second mappings 1, 3, 4 and 5 |
| Type 2 | Second mappings 1, 2 and 3 |
| Type 3 | Second mapping 3 |
| . . . | . . . |

Each of the first mappings includes a number of first mapping item identifiers stored with a respective corresponding first mapping score. The first mapping provides a direct, for example one-to-one, relationship between each first mapping item identifier and its respective corresponding first mapping score. Each first mapping may be stored in the form of a data table or any other suitable data structure.

In one example, each first mapping item identifier may be a restaurant menu item, and each score may represent the average increase in value associated with the menu item when said menu item is offered as an upsell item for an order with a restaurant. In this example, the first mapping may include every menu item from menus associated with one type of cuisine. An example of a first mapping is illustrated below.

| First mapping item identifier | First mapping score |
|---|---|
| First mapping item 1 | First mapping score 1 |
| First mapping item 2 | First mapping score 2 |
| First mapping item 3 | First mapping score 3 |
| . . . | . . . |

Each second mapping includes a number of second mapping item identifiers stored with a respective corresponding second mapping score. The second mapping provides a direct relationship, for example one-to-one, between each second mapping item identifier and its respective corresponding second mapping score. Each second mapping may be stored in the form of a data table or any other suitable data structure.

In one example, each second mapping item identifier of a particular second mapping may be a menu item, and each respective corresponding second mapping score may be a probability of selection of said second mapping item identifier as a supplementary item identifier. An example of a second mapping is illustrated below.

| Second mapping item identifier | Second mapping score |
|---|---|
| Second mapping item 1 | Second mapping score 1 |
| Second mapping item 2 | Second mapping score 2 |
| Second mapping item 3 | Second mapping score 3 |
| . . . | . . . |

Each of the second mappings 112 may correspond to one specific data source, such as one of data sources 401,402,403. Each of the plurality of second mapping item identifiers in a given second mapping may have originated from the corresponding specific data source. The server 100 may also have obtained the second mapping item identifiers over the network 200.

The plurality of first mapping item identifiers in a first mapping may include all item identifiers from second mappings 112 associated with the same type identifier as said first mapping. This configuration enables the data store to include, in one data structure, data for each item identifier from a plurality of data sources associated with a certain type identifier. The processor is configured to update this data structure to include new item identifiers, which enables quicker and more efficient data comparisons to be made when new item identifiers are compared with existing first mapping item identifiers.

The processor is configured to obtain a new item identifier associated with a particular second mapping. The new item identifier may originate from first data source 401, which sends the new item identifier message to the server 100 over network 200. The new item identifier message indicates that there is a new item identifier to be uploaded to the server 100. The new item identifier message may include the new item identifier. It is also preferable to attribute a second mapping score, of the correct format, to the new item identifier before it is stored in the particular second mapping in the data store.

The server 100 is configured so that the processor 120 may use the data store 110 to attribute the second mapping score to the new item identifier. The new item identifier is associated with the particular second mapping, which in turn is associated with at least one particular type identifier. The processor is configured to use at least one of the particular first mappings associated with said at least one particular type identifier. For example, the server 100 may receive a new menu item from a restaurant of a particular cuisine, and the processor is configured to attribute a score to the menu item using other menu items of the same cuisine.

The processor is configured such that, once the particular first mapping has been selected, it will parse the new item identifier using the particular first mapping item identifiers and their respective corresponding first mapping scores. Parsing is explained in more detail below. However, as a brief example, parsing involves comparing grams/bigrams of text in a new item identifier with grams/bigrams of text in first mapping item identifiers. The processor is configured to induce a score for the new item identifier based on the respective corresponding first mapping scores of first mapping item identifiers having a threshold level of textual similarity with the new item identifier. The processor 120 is configured to then update the particular second mapping to include the new item identifier and a second mapping score based on the induced score.

The user equipment 300 may be in the form of a personal computer, or a mobile telecommunications device for example. A user of the user equipment 300 may send a request message to the server 100, for example over the network 200. The server 100 is configured to receive the request message, which corresponds to a particular second mapping, and includes indication of selection of at least one particular second mapping item identifier.

In response to receiving the request message, the processor 120 may be configured to retrieve from the data store 110 the requested second mapping item identifiers. Selection of a second mapping item identifier in a request message may not require retrieval of said second mapping item identifier. Instead, it may involve retrieval by another means. For example, selection may indicate selection of menu items from a restaurant, and the retrieval involves said menu items being delivered to a house.

The processor is configured to select at least one second mapping item identifier, from the particular second mapping, which is to be sent as a supplementary item identifier in a supplement message to the user equipment 300. Selection is based on the particular second mapping scores, which includes the new item identifier second mapping score. Accordingly, the server 100 is configured to provide new item identifiers with second mapping scores which they would otherwise not have had.

The supplement message is configured to cause an association to be displayed between the second mapping item identifiers in the request message and the selected supplementary item identifier, for instance on a display at the user equipment 300. The displayed association enables the user to respond to the supplement message with an approval message indicating whether or not the user selected the supplementary item identifier.

The processor is configured to update the relevant second mapping score based on the indication of selection in the approval message.

Each second mapping score may represent a probability of selection of its respective corresponding second mapping item identifier. This probability is based, at least in part, on indications of selection in previous approval messages which included said second mapping item identifier. The processor may select, as a supplementary item identifier, second mapping item identifiers with scores which suggest the second mapping item identifier is more likely to be selected when offered as a supplementary item identifier.

The probability may also be based on the initial second mapping score attributed to the second mapping item identifier based on parsing the second mapping item identifier with the first mapping item identifiers. The processor may be configured to use both components (updates and initial) for determining the probability. For instance, up to a confidence threshold, the probability may be determined based on both components using an interpolation. For example, a linear interpolation may be used. Accordingly, the more a second mapping item identifier has been selected as a supplementary item identifier, the more the updates contribute towards determining the probability. Once the confidence threshold has been reached, the initial second mapping score will no longer be used for determining the probability.

The server 100 may be configured to receive the approval message over the network 200, and extract therefrom a simple yes/no message or details such as an indication of approval and the number of approved items. The processor 120 may be configured to respond, in the case that the approval message indicates selection, by retrieving the relevant second mapping item identifier and sending it to the user equipment.

The processor 120 may be configured to also update the relevant first mapping score based on the indication of selection of the supplementary item identifier in the acceptance message. It will be appreciated that this may be performed in the same manner as described above for the second mapping scores. Alternatively, the processor may be configured to periodically monitor any updates to the second mapping scores in the second mappings 112 and update the first mapping score accordingly.

The provision of a processor configured to update first mapping scores improves the usefulness of the parsing function of the processor. This is because when a new item identifier is parsed using a first mapping, the first mapping scores are up-to-date and are thus more representative of current trends. Parsing provides an initial second mapping score to the new item identifier and so avoids “cold-start problems” where there is no suitable score data for a new item identifier, because initial second mapping scores may be determined based on first mapping scores for similar item identifiers.

The configuration of the server 100 enables the processor to keep updated each of the first and second mappings 112 stored in the data store 110. In particular, the server 100 is configured to enable messages to be sent to and from the user equipment 300, and to determine, from these messages, updates to the relevant first and second mapping scores.

Network system 50 therefore provides a system which may provide supplement messages to the user equipment 300 having an increased likelihood of being useful to a user of said user equipment.

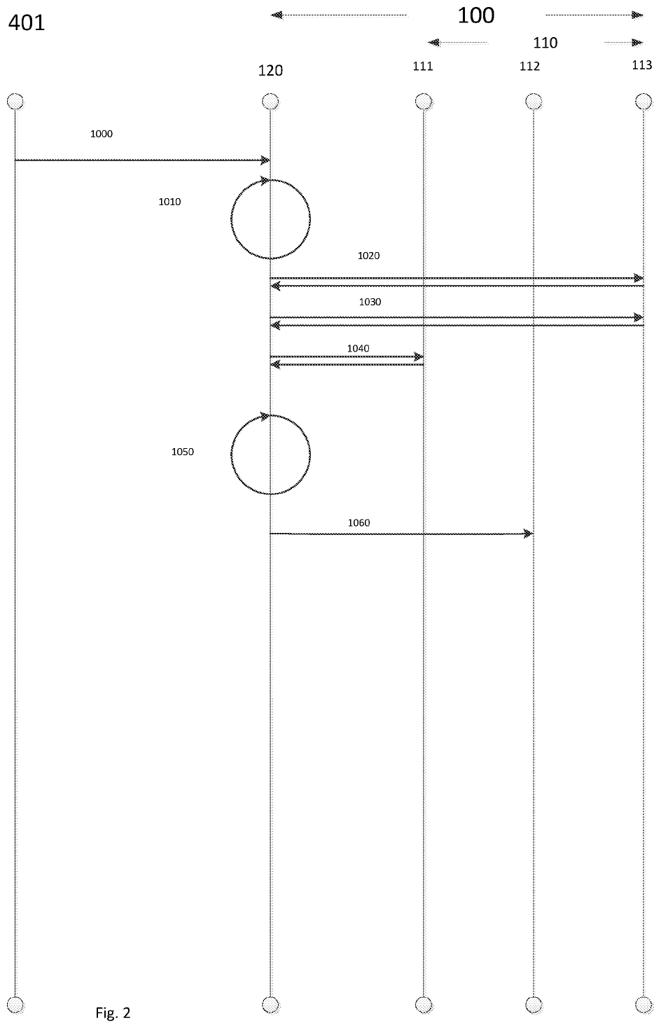

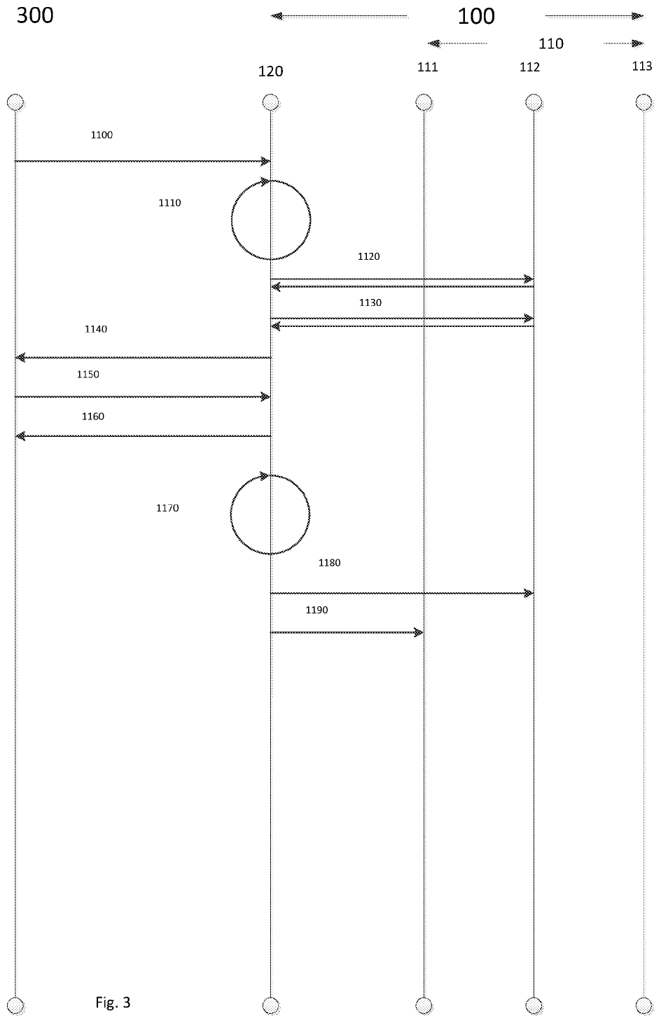

A method of operation of the network system 50 will now be described with reference to FIGS. 2 and 3.

25 In FIG. 2, at step 1000 a new item identifier message may be sent from the data source 401 to the server 100. This may be sent in a message format, or it may be communicated in another manner such as over the telephone, wherein someone may manually input the data into the server and there may be a message sent between different APIs on the server. Either way, at step 1010, the processor 120 obtains the new item identifier from the message and determines which second mapping it is associated with based on the new item identifier message. For example, the identity of the particular second mapping may be determined based on a mapping identifier included in the new item identifier message. The mapping identifier may be an indication of the data source from which the new item identifier was sent, such that the processor may determine the particular second mapping based on stored data associating known data sources with corresponding stored second mappings.

At step 1020, the processor determines, from the second association, the at least one type identifier associated with the particular second mapping. At step 1030, the processor determines, from the first association, the particular first mappings associated with the at least one type identifiers associated with the particular second mapping. At step 1040, the processor retrieves the associated at least one particular first mapping. Each first mapping may be stored indexed by a first mapping identifier, and thus the particular first mapping may be retrieved using its relevant first mapping identifier.

At step 1050, the processor parses the new item identifier using the at least one particular first mapping. There may only be one type identifier associated with the chosen second mapping, in which case the processor 120 would use the associated one particular first mapping. For each type identifier, there is only one associated first mapping, so the number of associated particular first mappings will be the same as the number of type identifiers associated with the particular second mapping.

It is to be understood in the context of this disclosure that parsing incorporates all suitable methods for comparing first mapping item identifiers with new item identifiers to assess a degree of similarity between the two. Depending on the degree of similarity between the new item identifier and the first mapping item identifier; a score may be induced to the new item identifier based on the first mapping score. The induced score may directly correspond to one first mapping score, for example only one first mapping score will be used to induce the score. Parsing may also include using more than one first mapping item identifier and respectively corresponding first mapping score. Here, the induced score may be based on the more than one first mapping scores.

In one embodiment, each of the first mapping item identifiers in the particular first mapping is in an alphanumeric format. Typically, this will include grams and/or bigrams of text. The new item identifier will also typically be in the same format. In this context, grams of text may refer to individual words of text, or chunks of alphanumeric code with no interstitial whitespace character.

Bigrams of text may refer to multiple grams in the order they appear in an item identifier. In the context of this application, the term bigrams is used to refer to any number of consecutive grams greater than one. They may also be referred to as “n-grams” or “shingles”. The processor is configured to perform a textual analysis on the new item identifier and the particular first mapping item identifiers. Several examples of such a textual analysis are discussed below.

When comparing grams and/or bigrams of text in the new item identifier with grams and/or bigrams of text in the first mapping item identifier, there are four common scenarios which are discussed below. As bigrams of text refer to strings containing a plurality of consecutive grams, it is possible that bigrams of text may be broken down into shorter bigrams of text. The methods discussed below apply to bigrams of any length, and so it is possible that two bigrams could be compared by looking at some of their constituent bigrams.

In a first scenario, the new item identifier and the first mapping item identifier are both a gram of text. Here, the comparison entails comparing the two grams like-for-like, and looking for matches between the two. Looking for matches will typically involve determining a degree of correlation between the two grams. It is to be understood in the context of the present disclosure that such a comparison could be achieved in a number of ways. In one example, the comparison may involve considering each individual character, its position in a gram, the total number of characters in said gram, then comparing with the other gram and looking for overlaps between the two grams.

In a second scenario, the new item identifier is a gram and the first mapping item identifier is a bigram. The comparison may be like-for-like, which involves comparing the entire bigram of text with the gram of text, in a manner analogous to the first scenario described above. Another approach involves breaking down the bigram of text into its component grams of text, and performing a comparison between each of the constituent grams of the bigram and the new item identifier gram, in the manner described above. Both approaches may be used to reveal global and local matches.

In a third scenario, the new item identifier is a bigram and the first mapping item identifier is a gram. This scenario is similar to the second scenario, and so the same methods may apply.

In a fourth scenario, both the new item identifier and the first mapping item identifier are bigrams of text. This comparison may include any degree of breaking down bigrams and using methods from any of the above-described scenarios. The comparison may also be between both entire bigrams. It may be preferable to consider both to see global and local matches, as scores may be induced on both scales. For example, if constituent grams of bigrams are similar, a score could be induced only to the constituent gram.

The comparison of the new item identifier and the first mapping item identifiers is performed so that a score may be induced for the new item identifier. The score will be induced based on the degree of similarity between the new item identifier and the first mapping item identifiers. The effect of the above-mentioned textual analysis is that a match may be determined between the new item identifier and the first mapping item identifier. A match may also be determined between constituent parts of the item identifiers. The score induced to the new item identifier will be discussed below with reference to the determined match.

In an event where there is a first match between the new item identifier and the first mapping item identifier, the score attributed to the new item identifier will be based on the first corresponding first mapping score. A first match represents a degree of similarity above a first threshold, which may be considered to be a relatively high threshold. In this event, the score induced to the new item identifier may be induced directly from the corresponding first mapping score, such that only that one first mapping score is considered when determining the second mapping score to be attributed to the new item identifier.

In some embodiments, the comparison of the new item identifier with the first mapping item occurs in a consecutive manner and finishes as soon as a first match has been detected. In such embodiments, a score may be induced more quickly, but there will be some first mapping item identifiers which have not been considered for the comparison. It is to be understood that this approach could be adopted even when parsing the new item identifier with a plurality of first mappings.

In other embodiments, the new item identifier may be compared with all of the first mapping item identifiers regardless. If the comparison found more than one first match, then the second mapping score for the new item identifier may be determined based on all of the respective corresponding first mapping scores for first matches. Alternatively, the second mapping score could be based entirely on the first mapping item identifier with the highest match. In such embodiments, a score may not be induced as quickly, but it will be more representative of the particular first mapping. It is to be understood that such approaches could be adopted when parsing using a plurality of first mappings.

It is to be understood that both of the above approaches may also apply in scenarios where there is a complete match, such that both item identifiers are exactly the same.

In an event where there is a second match between the new item identifier and a first mapping item identifier, the score will be based, at least in part, on the respective corresponding first mapping score. A second match represents a degree of similarity above a second threshold, but below the first threshold. A second match may occur when constituent grams of the item identifiers have a high degree of similarity, such as to the first match standard, but the item identifiers, when considered as entire bigrams, do not meet the first match standard.

In such an event, a score may be induced to the constituent gram of the new item identifier in accordance with the above procedure for a first match. Scores may also be induced for the remaining constituent grams of the new item identifier based on second matches with other first mapping item identifiers. The overall score for the new item identifier may then be determined based on all of the constituent gram scores. It may alternatively be based only on the highest score or the only score in the case where only one second match occurred.

As an example, the new item identifier comprises the token “buffalo wings”, and there are no bigrams of text in the relevant first mapping which produce a first match. There is however a second match with the first mapping item identifier “spicy chicken wings” having a first mapping score of 0.3. If there is no other first mapping item identifier which gives rise to a second match then only the score of 0.3 will be used for determining the second mapping score for the token “buffalo wings”. However, if there was also a second match with the first mapping item identifier “buffalo mozzarella” having a first mapping score of 0.1, then the constituent “buffalo” gram may induce a score of 0.1 and the constituent “wings” gram may induce a score of 0.3. Both of these scores may then be used for determining the second mapping score for the token “buffalo wings”. For example, the two partial matches may be combined, e.g. by using an average.

Where there is neither a first nor a second match between the new item identifier and any of the particular first mapping item identifiers, the second mapping score for the new item identifier may be based on an average first mapping score for the particular first mapping. Alternatively, if there are any other suitable first mappings that could be used then the parsing could be repeated with another first mapping, or an arbitrary score may be induced.

In events where the new item identifier has either a second match or no match, there will be no identical first mapping item identifier in the particular first mapping. The new item identifier, and its induced score, may then be included into the first mapping. This increases the chance that future new item identifiers find a match in the particular first mapping.

The above-mentioned method enables new item identifiers to be attributed scores that might be useful, which they otherwise would not have had. As the scores are attributed based on similar items, the usefulness is expected to be optimised. This addresses problems associated with recognising only a low degree of similarity between item identifiers, even though they are still similar in constituent parts. For instance, where the new item identifier differs slightly from previous item identifiers, it is possible to parse the new item identifier and to obtain a score which will be of more use than having no score at all.

At step 1060, once the score has been induced for the new item identifier, it may be stored in the particular second mapping. Accordingly, the new item identifier becomes a second mapping item identifier, and the respective corresponding second mapping score will be based on the induced score. Second mapping scores are discussed in more detail below, but they are probabilities, whereas the first mapping score, and thus the induced score, typically represent empirical data. It is useful to determine the second mapping score before including it in the second mapping, but it will still be determined based on the induced score.

In FIG. 3, at step 1100, the server 100 receives a request message from the UE 300. The request message comprises indication of selection of at least one second mapping item identifier associated with a particular second mapping. At step 1110, the processor identifies the particular second mapping, and at step 1120, the processor may retrieve the at least one second mapping item identifier from the particular second mapping. At step 1130, the processor selects a second mapping item identifier from the particular second mapping, and at step 1140, sends the selected second mapping item identifier as a supplementary item identifier included in a supplement message.

The supplementary item identifier is selected based on the second mapping scores. Each second mapping score corresponds to a probability of selection, as a supplementary item identifier, for the respective corresponding second mapping item identifier. The scores may therefore be considered as weightings, as the second mapping item identifiers are picked at random, but with the higher weighted scores being more likely to be selected.

The probability of selection may be determined in accordance with a bandit algorithm. It is to be understood in the context of this disclosure that the term bandit algorithm refers to any suitable algorithm which may be used for addressing a bandit problem. Bandit problems relate to situations where there are a plurality of possible options a user could take, each option having a reward associated with it and a corresponding probability distribution for the probability of receiving the reward, but the user has an imperfect knowledge of all of the rewards and their corresponding probability distributions. Bandit problems may also be referred to as “multi-armed bandit problems” or “N-armed bandit problems”.

To address bandit problems, bandit algorithms are designed to optimise a particular metric or score. Optimising this metric will typically involve establishing a balance between “exploring” behaviour and “exploiting” behaviour. In this context, “exploring” relates to selecting an option which the user does not have perfect knowledge of, so that the outcome of such a selection cannot be so accurately predicted, but will improve the user's knowledge of that option. The term “exploiting” relates to selecting, based on the user's present knowledge, options which the user would expect to result in the best rewards.

The bandit algorithm used may be an epsilon-decreasing algorithm. The term “epsilon-decreasing algorithm” refers to any suitable bandit algorithm in which the amount of exploring performed by the algorithm decreases over time. For instance, such an algorithm may initially focus predominantly on exploring, so as to get a better understanding of the likely rewards associated with each option. Over time, this will result in an increased knowledge of which options may be the most rewarding, and so the algorithm may then focus predominantly on selecting options which are known to be more rewarding. The exact nature of the bandit algorithm may vary depending on circumstances such as the amount of knowledge a user has. For instance, in situations where the user has a relatively high level of initial knowledge, the algorithm may only select exploring options very rarely.

In some embodiments, the bandit algorithm may be implemented through the second mapping scores. This may be achieved by having dynamic second mapping scores, such that the second mapping scores are updated over time. For example, each of the second mapping scores may be calculated using a formula which incorporates supplementary item identifier selection data for each second mapping item identifier. The formula may include an exploring component and an exploiting component.

The exploring component may be an inverse function of the number of times the second mapping item identifier has been selected as a supplementary item identifier. Accordingly, the contribution of the exploring component to the probability for selection will decrease in size as the number of times the option has been selected increases. It is preferable to include a normalising coefficient to this score, which ensures that the probability of selection for new item identifiers is not biased against.

The exploiting component for each second mapping score is based on previous score data associated with supplementary item identifier selection for the corresponding second mapping item identifier. This may be calculated using a ranking system, where each item identifier in the list data is ranked in order based on the previous score data, and the rank is used in an exponent such that higher ranked items are given an exponentially greater weighting than lower ranked items. Alternatively, the exploiting component may just be the previous score data associated with supplementary item identifier selection for the corresponding second mapping item identifier. The exploiting component may initially start using the ranking system and then transition to using the score system, once a threshold number of scores have been attained.

When a new item identifier is added to a second mapping with a second mapping score based on an induced score which resulted from parsing the new item identifier with a first mapping, the exploiting component of the second mapping score will initially be based primarily on the induced score. This second mapping score may be updated every time the second mapping item identifier is selected as a supplementary item identifier, such that this second mapping score will transition from initially being based primarily on the induced score, to eventually being based primarily on the updates. This enables the second mapping scores to remain up to date, and thus adapt to trends and temporal fluctuations, which enables more useful supplementary item identifiers to be selected. The exploiting component of the second mapping score may be configured to be based only on a certain number of the most recent updates so that older score data is discarded and the second mapping score is more representative of recent data.

The formula for the second mapping scores may include a plurality of parameters which are used to control the nature of the bandit algorithm. There may be a parameter which is adjustable to control the ratio of exploring to exploiting of the algorithm. There may also be a parameter which limits the number of updates used when calculating the exploiting component of the second mapping score, or there may be a parameter for the exponent when the ranking system is in use.

In order to ensure that the parameters used produce useful results, a Monte Carlo simulation may be used. Here, parameters are chosen and arbitrary scores are induced for the second mapping item identifiers. A trial run is performed using randomly generated numbers to determine whether or not selection occurs when a supplementary item identifier is offered. Typically, bandit algorithms will converge over time so that they only exploit a select few options, often only one. Therefore, the Monte Carlo analysis may be used to ensure the parameters selected are suitable enough to allow a convergence of the algorithm. The parameters may be refined until adequate convergence has occurred, at which point the refined parameters may be incorporated into the formula for determining second mapping scores.

In some embodiments, it may be preferable to use a formula in which the exploring component always remains above a threshold value, and so the algorithm will always include a certain amount of exploring behaviour. This may be advantageous in situations where the probability distribution and associated reward for selection of a second mapping item identifier have a time dependency, such that knowledge of the initial distribution and reward may no longer be accurate. It is thus preferable in such situations to ensure that any changes don't go unnoticed.

In some embodiments, the second mapping score will be dependent on the item identifiers included in the request message, such that probability of selection as a supplementary item identifier is influenced by the contents of the request message. This may be implemented by incorporating a temporary coefficient to the second mapping scores. For instance, it may be preferable not to select, as a supplementary item identifier, any second mapping item identifiers included in the request message. This may be achieved by the temporary coefficient for the second mapping score switching from one to zero, thus attributing a temporary second mapping score of zero to all second mapping item identifiers included in a request message.

In some embodiments, the probability of selection of a second mapping item identifier may include a degree of conditionality on the second mapping item identifiers included in the request message. This may be referred to as a contextual bandit algorithm, and is configured for ‘targeted delivery’ of supplementary item identifiers.

The updates to the second mapping score may incorporate a reference to the second mapping item identifiers included in the request each time the corresponding second mapping item identifier was selected as a supplementary item identifier. This enables the formula to determine that certain supplementary item identifiers work particularly well, or not, when certain other second mapping item identifiers are included in the request message. In the restaurant example, chips may be a useful upsell item to offer when the request message includes fish, but not when the request message includes rice.

At step 1140, the supplementary item identifier is selected and sent, in a supplement message, to the UE. The supplement message is configured to cause the UE to provide an association between the second mapping item identifiers included in the request message and the selected supplementary item identifier. This association may be in the form of an option to which the user may respond indicating selection or not, and where selection is indicated, a number of the selected supplementary items.

At step 1150, the UE sends an approval message to server 100, which includes an indication of whether the user has selected the supplementary item identifier or not. Where the approval message indicates selection, the processor may retrieve from the data store the corresponding second mapping item identifier and include this in a final message sent to the UE at 1160. The final message provides confirmation to the UE of what has been selected by the user, and where necessary the second mapping item identifiers associated with said selection.

At step 1170, the processor determines the updates to the second mapping scores based on the approval message. The update will reflect both the second mapping item identifier being offered as a supplementary item identifier and whether or not it was selected. The exploiting component of the second mapping score is updated to include whether or not that offering was successful, and thus to give further indication of the likely reward associated with selection of the supplementary item identifier. The exploring component will be reduced to reflect the increased knowledge associated with the supplementary item identifier. Accordingly, where the acceptance message indicates selection, the second mapping score will be incremented, and where it indicates no selection, the second mapping score will be decremented.

The processor also determines an update to the corresponding first mapping score, which will be based on whether or not the supplementary item identifier was selected.

At step 1180 the processor updates the second mapping accordingly, and at step 1190 the processor updates the first mapping accordingly.

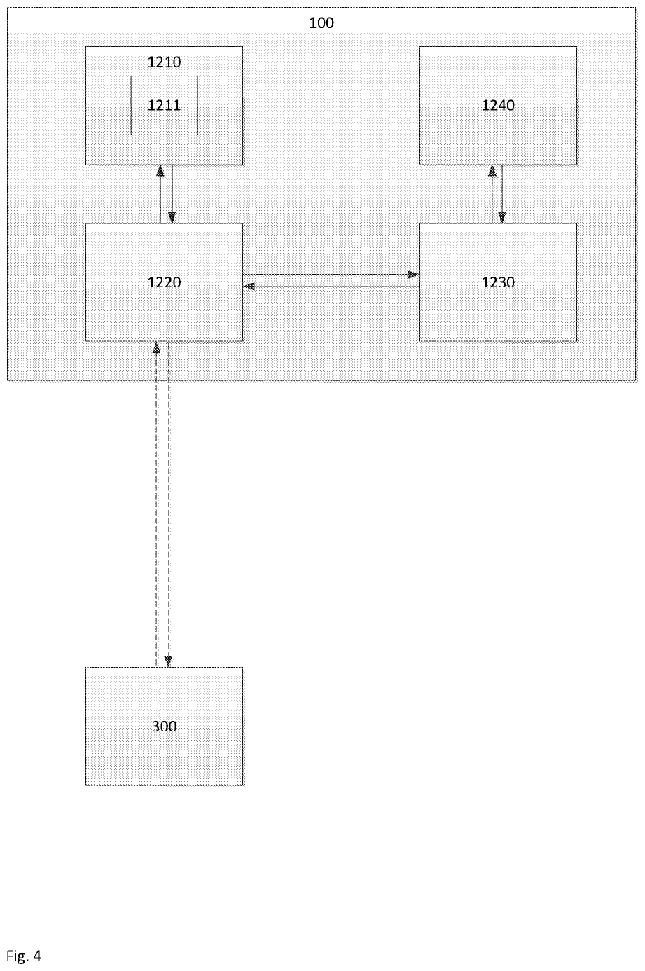

FIG. 4 illustrates an embodiment in which the server 100 comprises a plurality of APIs configured to perform the functionality of the server 100. The server 100 comprises Basket API 1210, Consumer Web 1220, Suggestion API 1230 and logic 1240. Consumer web 1220 is coupled with basket API and suggestion API, and suggestion API is coupled with logic 1240. Consumer web is also configured to communicate with UE 300.

A user of the user equipment may, prior to sending the request message, prepare said message by selecting items on a display at the UE. Consumer web is configured to detect such selections and in response to detecting a selection, communicate selection data to Basket API. Basket API comprises a data store 1211, which stores an association between a plurality of basket IDs and their corresponding selection data. Each basket ID relates to one user equipment and the corresponding selection data includes second mapping item identifiers having been selected by the user.

The user may then finalise the request message and send it to Consumer web. Consumer web is configured to receive the message, and determine from the message a basket ID associated with the user equipment. Consumer web may then retrieve, from Basket API, the selection data associated said basket ID. It is to be understood in the context of this disclosure that the indication of selection of at least one second mapping item identifier in the request message may incorporate receiving the request message and retrieving from Basket API the selection data associated with said basket ID.

Consumer web is configured to then send to suggestion API the selection data and a second mapping identifier for the relevant second mapping. Suggestion API is configured to then determine which second mapping item identifier is to be selected as the supplementary item identifier. Suggestion API then communicates the selected supplementary item identifier to Consumer web, which then sends the supplementary item identifier to the user equipment. Logic 1240 is configured to communicate with suggestion API to determine which supplementary item identifier was selected, and whether or not the user indicated selection of the supplementary item identifier. Logic 1240 may then update the relevant first and second mapping scores.

In another embodiment, the processor is configured to obtain list data comprising a plurality of item identifiers, wherein the list data is associated with a new second mapping. The new item identifiers may have originated from a new data source. The processor is configured to determine at least one type identifier associated with the new second mapping. The at least one type identifier may be obtained from the new data source. Alternatively, the processor may parse the new item identifiers with all first mappings and attribute a type to the new second mapping based on type identifiers for first mappings which include first mapping item identifiers having a high degree of similarity with the new item identifiers.

The processor is configured to create a new second mapping which is associated with the at least one determined type identifier, and to update the second association to include the association between the new second mapping and the associated at least one type identifier. The above-described procedure for determining second mapping scores may then be performed for each new item identifier in the list data. For example, this may be the procedure when the server 100 receives a menu for a new restaurant.

It is to be appreciated that the above description of first and second matches is not limiting, and that any combination of matches may be used when attributing a second mapping score to a second mapping item identifier. For example, the second mapping score may be based on all matches, both first and second. Accordingly, an average may be taken. The average may be weighted to reflect the type of each match.

In another embodiment, it may be preferable to refresh the second mapping scores in a second mapping. This may be particularly preferable where there are other second mappings associated with the same type identifier which receive a lot more request messages. Accordingly, the associated first mapping will include first mapping scores based on a lot more approval messages. The processor is thus configured to parse the second mapping item identifiers using a first mapping and to determine new second mapping scores based on induced scores from the parsing.

It is to be appreciated that although this disclosure mentions sending one supplementary item identifier, a plurality may be sent instead. For example, 6 supplementary item identifiers may be sent. Supplementary item identifiers may be selected to adhere to quotas based on characteristic of the data. For example, this may involve only offering a certain number of supplementary menu items for each course, e.g. starter, main or side.

It is to be appreciated that a request message for second mapping item identifiers in the second mapping may include a request message both including details of said items, or a link to another data item stored on the server 100 which comprises the identity of the selected second mapping item identifiers.

It is to be appreciated that both the first and second mapping scores need not be stored in the data store at all times. For instance, these scores may be determined on-the-fly based on previous data which is stored in the data store.

In some embodiments, filters may be applied before selecting the supplementary item identifier. The filters may be configured to apply a zero weighting to certain item identifiers which may not be appropriate. For example, where the supplementary item identifiers are offered as upsell items, the filters may prevent very expensive items from being offered, as they are less likely to be useful.

It is to be appreciated that the first and second associations may be combined so that there is a single stored association associating type identifiers, first mappings and second mappings. Similarly, the second association may instead link every second mapping to its associated type identifiers. In one example, each type identifier may be a different type of cuisine, and each associated second mapping includes menu items from one restaurant of that cuisine.

It is to be appreciated that any updates to the first and/or second mappings may not occur immediately, and instead, update data may be stored temporarily in the server 100 before the processor performs a series of updates. These may be performed on a schedule, such as once a day, for example overnight when the server 100 is likely to be less busy.

It is to be appreciated that the structure of the data store and the nature of the first and second mappings may be different. For example, the processor may be configured to parse new second mapping item identifiers using second mapping item identifiers stored in other second mappings rather than using a first mapping.

The first mappings have been described as including all second mapping item identifiers from all second mappings of the same type. However, very similar second mapping item identifiers may not be stored as separate first mapping item identifiers. For instance, where there is a first match between two item identifiers, only one may need to be stored in the first mapping. Alternatively, this may be determined by considering the difference in scores, such that similar first mapping item identifiers may be stored separately where they have very different scores.

Second mappings associated with more than one type identifier may have primary and subsidiary type identifiers such that the first mapping selected for parsing may be based on the primary type identifier rather all type identifiers associated with the second mapping. Additionally, new item identifier or second mapping item identifier in a particular second mapping may be associated with its own type identifier, rather than the type identifier for the particular second mapping. Accordingly, the first mapping for parsing may be selected using the individual type identifier.

It is to be appreciated that the bandit algorithm may be implemented using a different system, in which case the second mapping scores may correspond more directly to the first mapping scores. Accordingly, the processor may be configured to implement the bandit algorithm in another manner, for instance, implementing the exploring and exploiting behaviour into the function for randomly selecting second mapping item identifiers.

The type identifiers of the stored mappings may change over time, and so it may be desirable when a second mapping changes type identifier to parse the second mapping item identifiers using the first mapping associated with a new type identifier of the second mapping.

In one example, the server 100 may include menus for different restaurants, where it may be desirable to offer additional menu items to a user after they have selected the contents for their order. The scores for the menu items may be related to the probability of a user also including the additional menu item in their order, when it is offered to them as an additional menu item. The server 100 may use scores for similar existing menu items to estimate a suitable score for a new menu item, and thus menu options to be offered as additional items may be selected to attempt to maximise the likelihood of their acceptance.

In an aspect there is provided a server for providing upsell offers in an e-commerce system, the server comprising a language model in which each of a set of tokens has a score. The server is configured to: infer a score for an unknown item in a list of items for a vendor in the e-commerce system, wherein the inferred scores are based on the language model; update a score based on user behaviour; and select upsell items based on the scores.

This enables all items on the server to have scores which may aid in determining whether to offer the item as an upsell item. For instance, the unknown item has a score inferred based on the language model, where this item would otherwise not have had a score. The score for this unknown item may then be updated to reflect user behaviour, i.e. the score may adapt over time and be more representative of user behaviour. Accordingly, the server may be able to adapt so that when selecting upsell items, the upsell items offered are those more likely to be useful.

In an embodiment, the server may be configured to provide an upsell offer comprising an upsell item to a user device. The server may provide the upsell offer in response to receiving a request message from the user device.

In an embodiment, the server may be configured to select upsell items based on inferred scores until a confidence threshold is reached. The server may be configured so that above the confidence threshold the upsell items are selected based primarily on the score updates. For example, the server may be configured to use a form of interpolation, wherein the scores have a component based on the inferred score and a component based on the updates to the scores, and the interpolation is such that the contribution to the overall score from the inferred component decreases as more updates are received. Accordingly, the initial contribution is based primarily on the inferred score, but this contribution diminishes up to the confidence threshold, above which the contribution may be based entirely on the updated component.

In embodiments, the server is configured to avoid offering an item for upsell which is already in a customer's basket. The request message sent by the user may comprise a basket including a selection of the items the user has selected for purchase. In response, the server may send the upsell offer to the user device, for example in the form of a checkout message where the user is presented with an option to select the upsell item if they wish. The server may be configured so that in response to receiving the request message, the processor determines the items that are already in the user's basket and does not offer these items as upsell items.

The server may include any one or more of the features of the servers described and/or claimed herein. For example, the language model may be provided by the ‘first mapping’ of those servers. For example, the list of items provided by the vendor may be provided by the ‘second mapping’. The unknown item may be identified using an item identifier and a type identifier as defined elsewhere herein and in the appended claims. Likewise, the language model may be one of a plurality of such models, each associated with a type identifier. The list of items for the vendor may be one of a plurality of lists, each list being associated with one vendor and at least one type identifier.

Additionally, the tokens comprised within the language model may be provided by the ‘item identifiers’ and their scores provided by respective corresponding ‘first mapping scores’. Likewise, each item in the list of items for each vendor may be provided by an ‘item identifier’, each of said items having a score provided by a ‘second mapping score’. The unknown item may be provided by an item identifier associated with one of the lists of items for a vendor, and the inferred score is based on a language model associated with one of the type identifiers associated with said list of items provided by the vendor. The inferred score may be determined by parsing the unknown item using the language model, and the inferred score may provide a ‘second mapping score’ for a new item in a ‘second mapping’. Likewise, the update to the score may be provided to such a ‘second mapping score’ for an item identifier associated with the user behaviour.

Selecting the upsell items based on the scores may be provided based on ‘the second mapping scores’. This may be provided in response to receiving a request message from a UE for items identified in the second mapping, which the server is configured to send, in response, the upsell offer including the upsell item. The server comprising a data store and processor as described herein and set out in the appended claims.

Examples have been described above where the server 100 is used to control orders placed at a series of takeaway restaurants. However, the scope of the claims is considered to extend beyond such examples, and could be used in many more scenarios. For example, the server 100 may be an online library resource, and each second mapping may represent a text available to the public. Accordingly, a user may select a text they wish to retrieve, and in response the processor may send an optional extra text, in particular, an optional extra text which is likely to be of use with the selected text.

The user equipment illustrated in FIG. 1 has been described as a mobile telecommunications handset, but it will be appreciated in the context of the present disclosure that this encompasses any user equipment (UE) for communicating over a wide area network and having the necessary data processing capability. It can be a hand-held telephone, a laptop computer equipped with a mobile broadband adapter, a tablet computer, a Bluetooth gateway, a specifically designed electronic communications apparatus, or any other device. It will be appreciated that such devices may be configured to determine their own location, for example using global positioning systems GPS devices and/or based on other methods such as using information from WLAN signals and telecommunications signals. The user device may comprise a computing device, such as a personal computer, or a handheld device such as a mobile (cellular) telephone or tablet. Wearable technology devices may also be used. Accordingly, the communication interface of the devices described herein may comprise any wired or wireless communication interface such as WI-FI®, Ethernet, or direct broadband internet connection, and/or a GSM, HSDPA, 3GPP, 4G or EDGE communication interface.

Messages described herein may comprise a data payload and an identifier (such as a uniform resource indicator, URI) that identifies the resource upon which to apply the request. This may enable the message to be forwarded across the network to the device to which it is addressed. Some messages include a method token which indicates a method to be performed on the resource identified by the request. For example these methods may include the hypertext transfer protocol, HTTP, methods “GET” or “HEAD”. The requests for content may be provided in the form of hypertext transfer protocol, HTTP, requests, for example such as those specified in the Network Working Group Request for Comments: RFC 2616. As will be appreciated in the context of the present disclosure, whilst the HTTP protocol and its methods have been used to explain some features of the disclosure other internet protocols, and modifications of the standard HTTP protocol may also be used.

As described herein, network messages may include, for example, HTTP messages, HTTPS messages, Internet Message Access Protocol messages, Transmission Control Protocol messages, Internet Protocol messages, TCP/IP messages, File Transfer Protocol messages or any other suitable message type may be used.

The processor 120 of the server 100 (and any of the activities and apparatus outlined herein) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data store of the server 100 (and any of the apparatus outlined herein).

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. For example the functionality provided by the data store may in whole or in part be provided by a processor having one more data values stored on-chip. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in not-transitory form. Hardware includes computers, handheld devices, programmable processors, general purpose processors, application specific integrated circuits, ASICs, field programmable gate arrays, FPGAs, and arrays of logic gates.

Other examples and variations of the disclosure will be apparent to the skilled addressee in the context of the present disclosure.

1. A server comprising a data store, and a processor coupled to the data store, wherein the data store comprises:
a plurality of type identifiers, each associated with a respective corresponding one of a plurality of first mappings; and
a plurality of second mappings, each associated with at least one of said plurality of type identifiers,
wherein each of the plurality of first mappings comprise a plurality of item identifiers each having a respective corresponding first mapping score attributed thereto, and
wherein each of the plurality of second mappings comprise a plurality of item identifiers each having a respective corresponding second mapping score attributed thereto, and the processor is configured to:
obtain an item identifier associated with one of the second mappings;
update the one of the second mappings to include the item identifier and a second mapping score attributed to the item identifier, wherein the processor is configured to determine the second mapping score by parsing the item identifier using a first mapping selected from the plurality of first mappings based on the type identifier of the second mapping; and
wherein the server is configured so that in the event that a request message is received, from a UE, for items identified in the second mapping, the server sends, to the UE, a supplement message comprising a supplementary item identifier selected from the second mapping based on the second mapping scores in said second mapping.

2. The server of claim 1 wherein the processor is configured to update the second mapping score associated with the supplementary item identifier based on an approval message received from the UE in response to the supplement message.

3. The server of claim 2 wherein the processor is configured to update, based on the approval message, the first mapping score associated with the supplementary item identifier.

4. The server of either one of claim 2 or 3 wherein the processor is configured to determine, based on the approval message, the update to the second mapping score associated with the supplementary item identifier.

5. The server of claim 4 wherein the update in the second mapping score associated with the supplementary item identifier comprises incrementing said second mapping score in the event that the approval message indicates selection of the supplementary item; and
decrementing said second mapping score in the event that the approval message does not indicate selection of the supplementary item.

6. The server of any one of claims 2 to 5 wherein each of the second mapping scores in the data store comprises an exploring component and an exploiting component.

7. The server of claim 6 wherein the processor is configured to transition from a first mode, in which the exploiting component of the second mapping score associated with the supplementary item identifier in the second mapping is predominantly based on the score attributed to the corresponding item identifier, to a second mode, in which the exploiting component of the second mapping score associated with the supplementary item identifier in the second mapping is predominantly based on the updates to the second mapping score associated with the supplementary item identifier.

8. The server of any one of the preceding claims wherein the processor is configured to select the supplementary item identifier using a bandit algorithm.

9. The server of claim 8 wherein the bandit algorithm is an epsilon decreasing algorithm.

10. The server of any one of claim 8 or 9 wherein the processor is configured to perform the bandit algorithm using a parameter which is adjustable to influence the ratio of exploring to exploiting performed by the algorithm.

11. The server of any one of the preceding claims wherein each of the plurality of item identifiers in the selected first mapping comprise grams and/or bigrams of text.

12. The server of claim 11 wherein the obtained item identifier comprises grams and/or bigrams of text.

13. The server of claim 12 wherein the processor is configured to parse the obtained item identifier with the item identifiers in the selected first mapping.

14. The server of claim 13 wherein the processor is configured to use the textual analysis so that:
in the event that there is a first match between the grams and/or bigrams of text in the obtained item identifier and grams and/or bigrams of text in a particular item identifier in the selected first mapping, the processor determines the second mapping score to be attributed to the obtained item identifier based on the respective corresponding first mapping score attributed to said particular item identifier.

15. The server of claim 13 or 14 wherein the processor is configured to use textual analysis so that:
in the event that there is a second match between the grams and/or bigrams of text in the obtained item identifier and grams and/or bigrams of text in a plurality of particular item identifiers in the selected first mapping, the processor determines the second mapping score to be attributed to the obtained item identifier based, in part, on each of the respective corresponding first mapping scores attributed to said particular item identifiers.

16. The server of claims 13 to 15 wherein the processor is configured to use textual analysis so that:
in the event that there is no match between the grams and/or bigrams of text in the obtained item identifier and grams and/or bigrams of text in a particular item identifier in the selected first mapping, the processor determines the second mapping score to be attributed to the obtained item identifier based on an average for respective corresponding first mapping scores in the selected first mapping.

17. The server of claim 15 wherein the processor is configured so that in the event that there is a second match between the grams and/or bigrams of text in the obtained item identifier and the grams and/or bigrams of text in the plurality of particular item identifiers in the selected first mapping, the processor determines the second mapping score to be attributed to the obtained item identifier based on an average of the respective corresponding first mapping scores attributed to said particular item identifiers.

18. The server of any one of the preceding claims wherein the server is configured to respond to the request message from the UE, which comprises a user-assembled data request, with a supplement message configured to cause the UE to provide an association between the requested data and the selected supplementary item identifier.

19. The server of any one of the preceding claims wherein each second mapping score associated with a respective corresponding item identifier in the second mapping corresponds to a probability of selection, as a supplementary item identifier, of the respective corresponding item identifier.

20. The server of claim 19 wherein the processor is configured such that the probability of selection of the supplementary item identifier is dependent on at least one item identifier associated with the request message.

21. The server of claim 20 wherein the processor is configured to avoid selection of, as a supplementary item identifier, an item identifier associated with the request message.

22. The server of claim 21 wherein the processor is configured to assign a zero probability of selection to all item identifiers associated with the request message.

23. The server of any one of the preceding claims wherein the plurality of type identifiers in the data store are associated with only one respective corresponding one of the plurality of first mappings

24. The server of either one of claim 16 or 17 wherein the processor is configured to update the first mapping to include the obtained item identifier in the event that there is either a second match or no match between the grams and/or bigrams of text in the obtained item identifier and grams and/or bigrams of text in any particular item identifier in the selected first mapping.

25. A server comprising a data store, and a processor coupled to the data store, wherein the data store comprises:
a plurality of type identifiers, each associated with a respective corresponding one of a plurality of mappings,
wherein each of the plurality of mappings comprises a plurality of item identifiers each having a respective corresponding score attributed thereto, and the processor is configured to:
obtain list data comprising a plurality of item identifiers and at least one type identifier;
attribute a score to each one of the item identifiers in the list data by parsing each one using at least one first mapping associated with the at least one type identifier of the obtained list data; and
wherein the server is configured so that in the event that a request message is received, from a UE, specifying an item identifier associated with the list data, the server responds to the request message by sending, to the UE, a supplementary item identifier selected from the list data based on the scores in the list data.

26. A server comprising a data store, and a processor coupled to the data store, wherein the data store comprises:
a plurality of type identifiers, each associated with a respective corresponding one of a plurality of first mappings; and
a plurality of second mappings, each associated with at least one of said plurality of type identifiers,
wherein each of the plurality of first mappings comprise a plurality of first item identifiers each having a respective corresponding first mapping score attributed thereto,
wherein each of the plurality of second mappings comprise a plurality of second item identifiers each having a respective corresponding second mapping score attributed thereto, and the processor is configured to:
obtain list data comprising a plurality of second item identifiers and at least one type identifier associated with the plurality of second item identifiers;
attribute a second mapping score to each of the plurality of second item identifiers in the list data based on parsing each said second item identifier using at least one first mapping associated with the at least one type identifier associated with the obtained plurality of second item identifiers;
provide a second mapping associated with the at least one type identifier, the second mapping comprising an association between the obtained plurality of second item identifiers and their respective corresponding second mapping scores; and
wherein the server is configured so that in the event that a request message is received, from a UE, specifying a second item identifier associated with the second mapping, the server responds to the request message by sending, to the UE, a supplementary item identifier selected from the second mapping based on the second mapping scores in said second mapping.

27. A computer-implemented method comprising:
obtaining an item identifier associated with a second mapping, the second mapping being associated with at least one type identifier and comprising a plurality of item identifiers and a respective corresponding plurality of second mapping scores;
attributing a respective corresponding second score to the item identifier based on parsing the item identifier using a first mapping associated with one of the at least one type identifiers associated with the second mapping;
updating the second mapping to include the item identifier and the attributed respective corresponding second mapping score;
receiving a request message, from a UE, specifying an item identifier associated with the second mapping;
sending a supplement message, to the UE in response to the request message, comprising a supplementary item identifier selected from the second mapping based on the second mapping scores in said second mapping.

28. A computer program product comprising program instructions configured to program a processor to perform the method of claim 27.
